(19) United States
(12) Patent Application Publication
(10) Pub. No.: US 2010/0131696 A1
(43) Pub. Date: May 27, 2010

(54) System and Method for Information Handling System Data Redundancy

(76) Inventors: Thomas L. Pratt, Austin, TX (US); Munif Mohammed Farhan, Round Rock, TX (US); Dirk Anders Erickson, Austin, TX (US)

Correspondence Address: HAMILTON & TERRILE, LLP, P.O. BOX 203518, AUSTIN, TX, 78720, US

(21) Appl. No.: 12/275,302

(22) Filed: Nov. 21, 2008

(51) Int. Cl. G06F 12/02; G06F 12/16; G06F 12/00

(52) U.S. Cl. 711/103; 711/112; 711/104; 711/162; 711/E12.001; 711/E12.103; 711/E12.008

(57) ABSTRACT

Flash memory integrated in a hard disk drive chassis maintains a back-up copy of data stored on the hard disk drive between back-ups of the hard disk drive data to separate storage devices. If the hard disk drive fails, the data on the flash memory provides a back-up of changes made since the previous hard disk drive back-up. When a back-up is made of data stored on the hard disk drive to an external storage device, the back-up on the flash memory device is erased to make room for subsequent back-up data. If back-up data stored on the flash memory approaches the capacity of the flash memory, a notice is provided to an end user that a back-up is needed.

### BACKGROUND OF THE INVENTION

1. Field of the Invention

The present invention relates in general to the field of information handling system data storage, and more particularly to a system and method for information handling system data redundancy.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems create and store data that often has a great deal of importance to businesses and individuals. Businesses often secure data from inadvertent or even intentional loss by maintaining back-up copies. For example, small businesses typically run tape drives periodically, such as at the end of each business day, so that a separate copy of data is maintained. Larger businesses often employ more advanced data redundancy schemes, such as maintaining mirror images of data at distal locations so that a disruption of on-site storage devices will allow a back-up from off-site storage devices. Individuals have traditionally maintained back-ups with local storage devices, such as tape drives or external hard disk drives, but have more recently been offered opportunities to back-up data with off site storage devices accessed through the Internet.

Periodic back-ups help to preserve data should a primary storage device fail, however, a periodic back-up does not preserve data created during the time period between back-ups. While the amount of data created between back-ups may be insubstantial in size relative to all of the backed-up data, the most-recently created data usually has greater relevance to a business or individual who uses the data. Performing data back-ups with greater frequency and the passage of less time between back-ups tends to reduce the impact of data loss, however, frequent data back-ups can interfere with the normal operations, thus annoying end users. One alternative is to integrate mirroring of stored data within an information handling system or storage system by incorporating multiple hard disk drives, such as with a RAID configuration. In the event of a failure of one hard disk drive, the data remains available from the mirrored hard disk drive. Although RAID configurations provide redundancy, the installation of the extra hard disk drive increases the cost of the system and the size of the system. Because RAID configurations require power and room for multiple hard disk drives, they are not normally used in portable information handling systems which are built to minimize power consumption and size. Regular data back-ups with portable information handling systems present a challenge since portable systems may not interface with stationary back-up storage devices at regular intervals.

### SUMMARY OF THE INVENTION

Therefore a need has arisen for a system and method which backs-up data at an information handling system without substantially increasing the size or power consumption of the information handling system.

In accordance with the present invention, a system and method are provided which substantially reduce the disadvantages and problems associated with previous methods and systems for backing up data at an information handling system. Non-volatile memory, such as flash memory, integrated in a hard disk drive chassis maintains intermediate back-up data for changes made to the hard disk drive between incremental back-ups.

More specifically, an information handling system has plural components built into a housing, such as a CPU, RAM, a hard disk drive, a chipset, a NIC and a display. The hard disk drive is backed-up at a storage device external to the information handling system, such as through a network. A redundancy module maintains back-up data in a flash memory that is integrated in the hard disk drive so that intermediate back-up data remains available for incremental back-up of the hard disk drive at the external storage device. The redundancy module monitors the capacity available in the flash memory and issues a notice that a back-up is needed if the flash memory available storage capacity is less than a predetermined threshold. If the data on the hard disk drive is successfully backed-up, the back-up data on the flash memory is erased so that the flash memory is reset to track new changes to the data on the hard disk drive. If the hard disk drive fails, the back-up data on the flash memory is retrieved so that a complete back-up of the hard disk drive remains available, including intermediate data changes made after an incremental back-up.

The present invention provides a number of important technical advantages. One example of an important technical advantage is that data is backed up at an information handling system without substantially increasing the size or power consumption of the information handling system. The relatively small amounts of flash memory used to maintain a concurrent back-up fits within the housing of a hard disk drive and shares the hard disk drive controller and power subsystem so that the impact of concurrent storage on system size and cost are minimal. The size of flash memory used for the concurrent back-up of information stored on the hard disk drive is minimized by reminding the end user to back-up the data at an external storage location at regular intervals and when the flash becomes full. Further, flash memory is likely to successfully store data under conditions where a hard disk drive might fail, such as when a portable information handling system is dropped causing damage to the rotating magnetic disk of the hard disk drive.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a hard disk drive having integrated flash memory that maintains a back-up of new information stored on the hard disk drive; and

FIG. 2 depicts a flow diagram of a process for maintaining a back-up of data stored on a hard disk drive in a flash memory associated with the hard disk drive.

### DETAILED DESCRIPTION

Flash memory integrated in a hard disk drive chassis maintains a back-up of data changes to the hard disk drive between back-ups of the hard disk drive to a separate storage device or information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

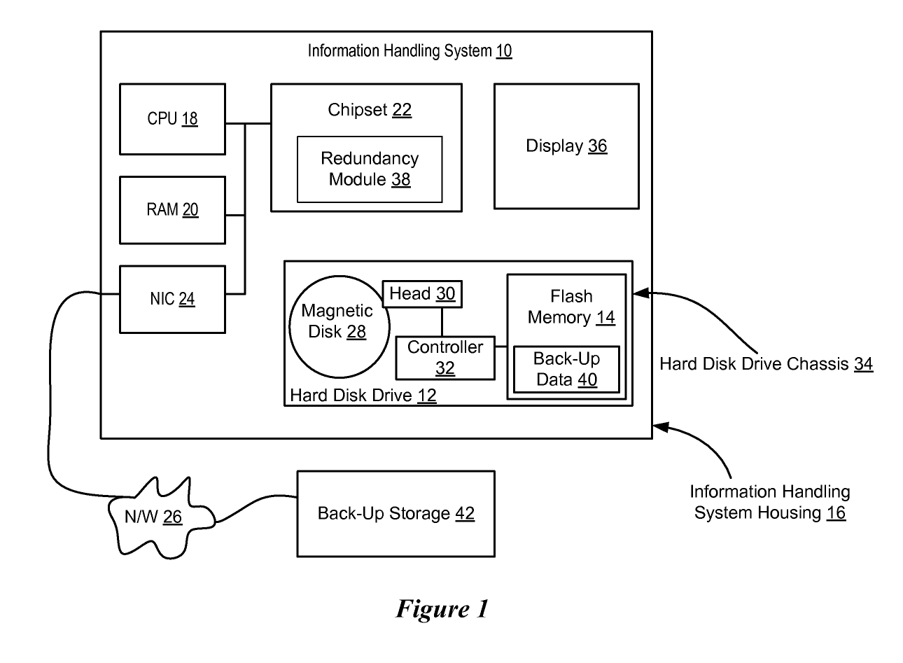

Referring now to FIG. 1, a block diagram depicts an information handling system 10 having a hard disk drive 12, the hard disk drive having integrated flash memory 14 that maintains a back-up of new information stored on the hard disk drive. Information handling system 10 is built in a housing 16 that supports a variety of components that cooperate to process information. A CPU 18 processes information using RAM 20 to provide temporary storage of information and a chipset 22 that has firmware instructions, such as a BIOS, to coordinate the interaction of hardware components. A network interface card (NIC) 24 supports network communications between information handling system 10 and a network 26, such as a local area network (LAN), a storage area network (SAN) or the Internet. Hard disk drive 12 provides permanent storage of information on a magnetic disk 28 which spins relative to a head 30. A controller 32 manages reads from disk 28 and writes to disc 28 by controlling head 30. Hard disk drive 12 is built into a chassis 34, which fits into information handling system housing 16. A display monitor 36 built into information handling system housing 16 supports the presentation of information in a portable system. Although FIG. 1 depicts integrated flash memory 14 to store information, other types of non-volatile memory could be used.

In operation, applications running on CPU 18 generate data for storage on hard disk drive 12. For example, an application running over an operating system on CPU 18 reads data from hard disk drive 12 and writes data to hard disk drive 12 through a driver of the operating system. As the data on hard disk drive 12 changes, a redundancy module 38 running in firmware of chipset 22 mirrors the changes as back-up data 40 stored in flash memory 14. Redundancy module 38 maintains back-up data 40 that reflects changes made to data stored on magnetic disk 28 since at least the most recent back-up of the data to a back-up storage 42. When information handling system 10 interfaces with back-up storage 42, a back-up is initiated either automatically on in response to an end user input. The back-up of hard disk drive is provided either directly from hard disk drive 12 or from back-up data 40 in flash memory 14. Once a back-up of hard disk 12 is completed at back-up storage 42, redundancy module 38 erases back-up data 40 and resets flash memory 14 to begin a new back-up of data changes made to hard disk drive 12. Although FIG. 1 depicts redundancy module 38 as running in firmware of chipset 22, in alternative embodiments redundancy module runs as firmware in hard disk drive 12, such as on controller 32, as a driver of an operating system running on CPU 18, such as Windows, or as a number of distributed modules that run on CPU 18, chipset 22 and hard disk drive 12.

During normal operations, redundancy module 38 maintains back-up data 40 as a mirror of changes made to data stored on hard disk drive magnetic disk 28 since the most recent back-up of hard disk drive 12. If available storage on flash memory 14 crosses a threshold value, redundancy module 38 initiates presentation of a notice at display 36 that a back-up is required. If hard disk drive 12 fails, then redundancy module 38 retrieves back-up data 40 to update back-up storage 42 so that a complete copy of the information stored on magnetic disk 28 is available in back-up storage 42. Even in the event of magnetic media failure, redundancy module 38 is still available to retrieve back-up data 40 to storage 42. Erasing back-up data 40 and resetting flash memory 14 at each back-up to back-up storage 42 minimizes the amount of flash memory 14 needed to maintain a current back-up of hard disk drive 12. Integration of flash memory into hard disk drive chassis 34 allows intermediate back-ups into flash memory 14 between back-ups of hard disk drive 12 with the controller and power subsystem of hard disk drive 12. Further, integration of flash memory 14 into hard disk drive chassis 34 ensures that the intermediate back-up data associated with hard disk drive 12 remains physically with hard disk drive 12.

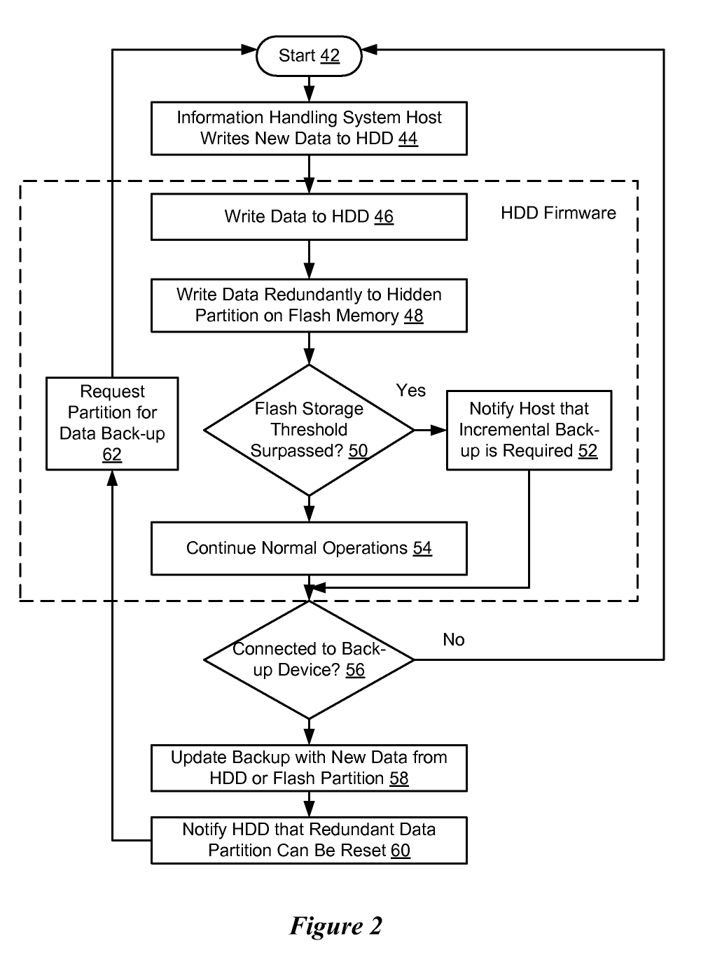

Referring now to FIG. 2, a flow diagram depicts a process for maintaining a back-up of data stored on a hard disk drive in a flash memory associated with the hard disk drive. The process starts at step 42, such as at power-up to the hard disk drive, and proceeds to step 44 for a change to the data stored on an information handling system hard disk drive 44, such as a write of new data. At step 46, the data is written to the hard disk drive magnetic disk, and at step 48 the data is redundantly written to a partition on flash memory, such as flash memory integrated into the chassis of the hard disk drive. At step 50, a determination is made of whether the flash memory storage capacity has reached a predetermined threshold. If the threshold has been reached indicating that the flash memory is approaching full capacity, the process continues to step 52 to notify the host information handling system that an incremental back-up is required due to the limited remaining back-up capacity. If the threshold is not reached, the process continues to step 54 to continue normal operations.

At step 56 a determination is made of whether the host information handling system is interfaced with a back-up storage device, such as an external storage device. If not, the process returns to step 42. If an external back-up storage device is available, the process continues to step 58 to update the back-up of the hard disk drive with new data from the hard disk drive or from the flash memory partition. After performing the back-up, the process continues to step 60 to notify the hard disk drive that the redundant data partition in the flash memory can be reset. At step 62, the partition for the data back-up is reset and the process returns to step 42. The dotted line around steps 46 to 54 and step 62 indicate the functions performed by hard disk drive firmware in one example embodiment.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor disposed in the housing and operable to process data;
RAM disposed in the housing and interfaced with the processor, the RAM operable to store data in cooperation with the processor;
a hard disk drive disposed in the housing and interfaced with the processor, the hard disk drive having a magnetic disk operable to store data, the magnetic disk spinning relative to a head, the head reading and writing information at the magnetic disk;
flash memory disposed in the housing and interfaced with the processor, the flash memory operable to store data; and
a redundancy module interfaced with the processor and the flash memory, the redundancy module operable to maintain a copy in the flash memory of data stored on the hard disk drive until the data is backed-up at a storage device external to the housing.

2. The information handling system of claim 1 wherein the redundancy module is further operable to delete data from the flash memory when the data is backed-up at the storage device external to the housing.

3. The information handling system of claim 2 wherein the redundancy module is further operable to issue a notice for a back-up if space available for storage of data in the flash memory is a predetermined amount.

4. The information handling system of claim 1 wherein the hard disk drive comprises a chassis that supports the magnetic disk, the head and the flash memory.

5. The information handling system of claim 4 further comprising a power subsystem disposed in the hard disk drive chassis, the power subsystem operable to power the magnetic disk, the head and the flash memory.

6. The information handling system of claim 4 further comprising a controller disposed in the hard disk drive chassis, the controller managing storage of data on the hard disk drive and the flash memory.

7. The information handling system of claim 6 wherein the redundancy module comprises firmware instructions running on the controller.

8. The information handling system of claim 1 wherein the redundancy module comprises a driver running on the processor.

9. The information handling system of claim 1 wherein the redundancy module comprises instructions associated with the storage device external to the housing.

10. A method for data redundancy comprising:
storing data on a hard disk drive of an information handling system;
automatically mirroring the data in flash memory;
maintaining the data in the flash memory until a back-up of the data from the hard disk drive to an external storage device; and
automatically deleting the data from the flash memory after a back-up of the data from the hard disk drive.

11. The method of claim 10 further comprising:
detecting a failure of the hard disk drive; and
retrieving the data from the flash memory to the external storage device.

12. The method of claim 10 wherein automatically mirroring further comprises automatically mirroring the data to flash memory located in a common chassis with the hard disk drive.

13. The method of claim 10 wherein automatically mirroring further comprises writing the data to the hard disk drive and to the flash memory with a common controller.

14. The method of claim 10 further comprising:
detecting that the data has used a predetermined portion of the capacity of the flash memory; and
in response to the detecting, presenting a notice at the information handling system to back-up the hard disk drive.

15. The method of claim 14 wherein presenting a notice further comprises generating the notice with firmware instructions that run independent of an operating system of the information handling system.

16. A system for managing data redundancy, the system comprising:
a chassis;
a hard disk drive disposed in the chassis;
non-volatile memory disposed in the chassis;
a controller disposed in the chassis and operable to control writes and reads at the hard disk drive and at the non-volatile memory; and
a redundancy module operable to copy to the non-volatile memory data that is written to the hard disk drive and to maintain the data in the non-volatile memory until a back-up of the hard disk drive to an external storage device.

17. The system of claim 16 wherein the redundancy module comprises instructions running on the controller.

18. The system of claim 16 wherein the redundancy module is further operable to erase the data from the non-volatile memory in response to a back-up of the hard disk drive.

19. The system of claim 16 wherein the redundancy module comprises firmware instructions running on an information handling system associated with the hard disk drive.

20. The system of claim 16 wherein the redundancy module is further operable to monitor available storage capacity and to issue a back-up notice if available storage capacity is a predetermined amount.
